(19) United States
(12) Patent Application Publication
(10) Pub. No.: US 2010/0167584 A1
(43) Pub. Date: Jul. 1, 2010

(54) STACKED-TYPE CONNECTOR

(75) Inventor: Hua HE, Pudong (CN)

Correspondence Address: MOLEX INCORPORATED, 2222 WELLINGTON COURT, LISLE, IL, 60532, US

(73) Assignee: MOLEX INCORPORATED, Lisle, IL (US)

(21) Appl. No.: 12/648,893

(22) Filed: Dec. 29, 2009

(30) Foreign Application Priority Data
Dec. 29, 2008 (CN) 200820189656.2

(51) Int. Cl. H01R 13/648

(52) U.S. Cl. 439/607.01

(57) ABSTRACT

A stacked-type connector includes a housing, a plurality of conductive terminals supported by the housing, two shields, and a spacer. A first and second tongue plate protrude from the housing in an upper and lower position and two latching arms extend from a rear portion of the housing. The plurality of the conductive terminals comprises a first terminal group and a second terminal group. The spacer comprises a main body portion and two latching portions protruding outwards respectively from two sides of the main body portion, the two latching portions configured to engage the two latching arms of the housing so as to secure the spacer on the rear portion. A plurality of positioning holes extend through the spacer in an vertical direction, and the tail portions of the plurality of the conductive terminals are inserted through the positioning holes of the spacer and protruded below the spacer.

### RELATED APPLICATIONS

This application claims priority to Chinese Utility Model Patent No. 200820189656.2, filed Dec. 29, 2008, which is incorporated herein by reference in its entirety.

### TECHNICAL FIELD

The disclosure relates to a stacked-type connector, and more particularly, to a stacked-type connector combined with at least two connector interface standards.

### BACKGROUND ART

A stacked connector is formed by two or more electrical connectors combined together in a stacked fashion with respect to the application of higher integrated level and more compact physical space. As disclosed in Chinese patent ZL 200720125333.2, a multiple-port type connector is formed by stacking one Displayport (integration image display connection port) connector with two USB (universal serial bus) transmission ports. The multiple-port type connector comprises a seat body, a Displayport connector, a USB connector, a close cover and a hollow outer shell body, wherein, a caulking groove is arranged on the seat body; a joint groove is arranged under the caulking groove; a sunken part is arranged on the back of the seat body; the upper part of the sunken part is provided with an assembling port which communicates with the caulking groove; a plurality of narrow slots are arranged on the wall surface of the sunken part. The Displayport connector is assembled and connected to the caulking groove, and the USB connectors are assembled and connected to the joint groove. The close cover is assembled and connected to the sunken part on the back of the seat body; the close cover has a bulging part which is assembled and connected to the assembling port of the sunken part; a plurality of raised lines are arranged on the wall surface of the close cover; the raised lines are pressed and clamped in the narrow slots; the hollow outer shell body is sleeved outside the seat body; a first through hole and a second through corresponding to a plug port and a USB plug slot are arranged on the front head face of the hollow outer shell body; the bottom of the lateral surface of the hollow outer shell body extends to form a group of connecting pins.

The connector structure disclosed in the above patent is configured with the plurality of narrow slots being are arranged on the wall surface of the seat body so that tail portions of the two rows of the conductive terminals of the Displayport connector are received in these narrow slots. Although this design is able to assure intervals in a left-right direction between the tail portions of the conductive terminals are not changed, the deficiency of this design lies in that: if these narrow slots are provided narrower to fasten the conductive terminals, there is a problem that it is difficult to clamp the conductive terminals into the slots during assembly process of the conductive terminals, and the tail portions of the conductive terminals are easily bent backwards and deformed during assembly; if these narrow slots are provided wider, the fastening effect in the fore-and-aft direction with respect to the tail portions of these conductive terminals is not obvious, and the fore-and-aft interval between the upper conductive terminal row and the lower conductive terminal row is easily changed when impacted, and even short circuit phenomena may occur between the tail portions.

### SUMMARY OF THE INVENTION

A stacked-type connector is provided that includes a housing with a first tongue plate and a second tongue plate, the first tongue plate complying with an interface standard of a first connector and the second tongue plate complying with an interface standard of a second connector. A plurality of conductive terminals are supported by the housing and each include a contact portion and a tail portion, the plurality of conductive terminals being comprised of a first terminal group complying with the interface standard of the first connector and a second terminal group complying with the interface standard of the second connector, the contact portions of the first terminal group and the contact portions of the second terminal group being respectively provided on the first tongue plate and the second tongue plate of the housing, and the tail portions of the first terminal group and the tail portions of the second terminal group extending out from a rear portion of the housing. At least one shield is mounted on the housing and a spacer is mounted to the rear portion of the housing. The space can include a main body portion and two latching portions protruding outwards respectively from two sides of the main body portion, the two latching portions respectively matched with the two latching arms of the housing so that the spacer is secured on the rear portion of the housing.

### BRIEF DESCIRPTION OF THE DRAWINGS

The present invention is illustrated by way of example and not limited in the accompanying figures in which like reference numerals indicate similar elements and in which:

FIG. 1 is an assembled perspective view of n exemplary embodiment of a stacked-type connector;

FIG. 2 is a front view of the stacked-type connector shown in FIG. 1;

FIG. 3 is a bottom view of the stacked-type connector shown in FIG. 1;

FIG. 4 is an assembled perspective view of the stacked-type connector of FIG. 1 from another view angle;

FIG. 5 is an assembled perspective view of the stacked-type connector of FIG. 1 from a still another view angle;

FIG. 6 is an exploded perspective view of the stacked-type connector illustrated in FIG. 1;

FIG. 7 is an exploded perspective view of the stacked-type connector of FIG. 1 from another view angle;

FIG. 8 is an exploded perspective view illustrating an assembly relation among an housing, a spacer and conductive terminals in the stacked-type connector depicted in FIG. 1;

FIG. 9 is an exploded perspective view illustrating an assembly relation among an housing, a spacer and the conductive terminals in the stacked-type connector depicted in FIG. 1 with another view angle;

FIG. 10 is an exploded perspective view illustrating an assembly relation among an housing, a spacer and the conductive terminals in an embodiment of a stacked-type connector;

FIG. 11 is a perspective view illustrating an embodiment of a stacked-type connector mounted on a circuit board; and

FIG. 12 is a bottom view of the stacked-type connector shown in FIG. 11 after assembled with the circuit board.

### DETAILED DESCRIPTION OF THE PREFERRED EMBODIMENTS

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

In comparison with the prior art, one potential beneficial technical effect of depicted embodiment is that the design of spacer allows greater control of the spacing between the tail portions of the conductive terminals along front, rear, left, and right directions and helps ensure the spacing is not changed. In addition, the spacer can help prevent the tails portions from bending. Thus, the depicted features can help prevent the occurrence of a situation where the tail portions can not be assembled and soldered onto a circuit board due to inadvertent changes in the spacing or orientation of the tail portions caused, for example, by shipping and handling of the connector prior to installation.

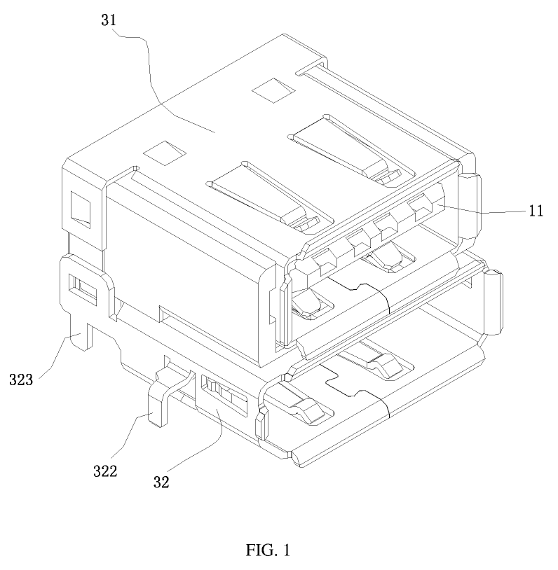

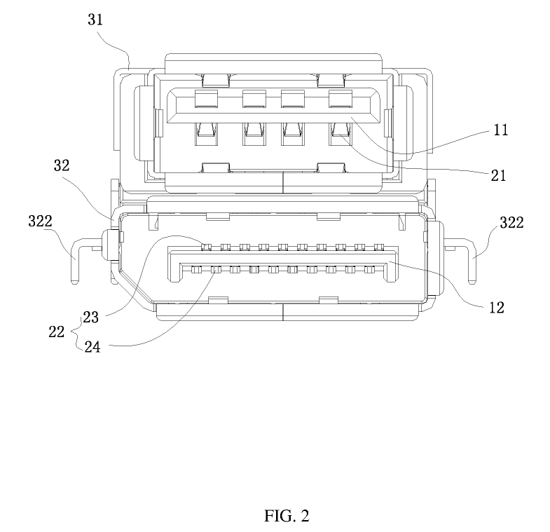

Referring to FIG. 1 through FIG. 10, an embodiment of a stacked-type connector is illustrated and comprises an assembly formed by stacking a Displayport connector socket with an USB connector socket. The stacked-type connector mainly comprises: an housing 1, a plurality of conductive terminals 2 mounted on the housing 1, a first shield 31, a second shield 32, a spacer 4, and a rear cover 5.

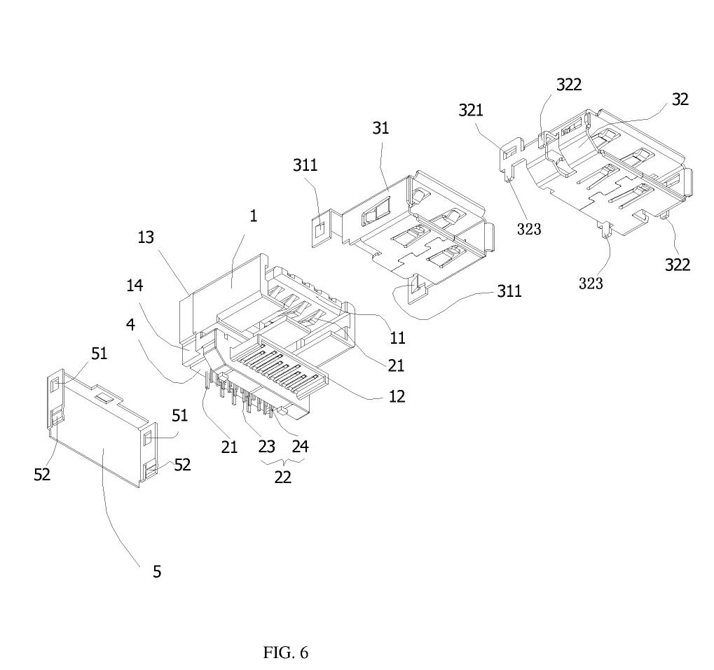

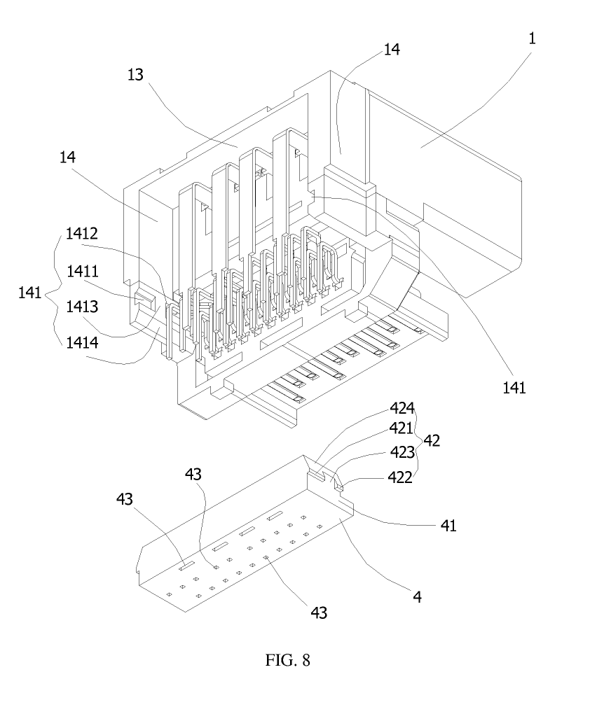

Referring to FIG. 6, the housing 1 is integrally formed by an injection molding process, and a first tongue plate 11 and a second tongue plate 12 protrude out forwards from the housing 1. Herein, the first tongue plate 11 located above complies with an interface standard of the USB connector socket, and the second tongue plate 12 located beneath complies with an interface standard of the Displayport connector socket. Referring to FIG. 8, the housing 1 is provided with two latching arms 14 downwards bent and extending from a rear portion 13 thereof, and each of the two latching arm 13 is provided with a buckling portion 141 at a tail end thereof, each of the buckling portions 141 of the two latching arms 14 is provided with two recess portions 1412, 1411, arranged along a fore-and-aft direction and a flat portion 1413 between the two recess portions 1411, 1412 at an inner side thereof, and the latching arm 14 is also provided with a ramp 1414 gradually inclining inwards in bottom-up direction at an inner side of the tail end thereof.

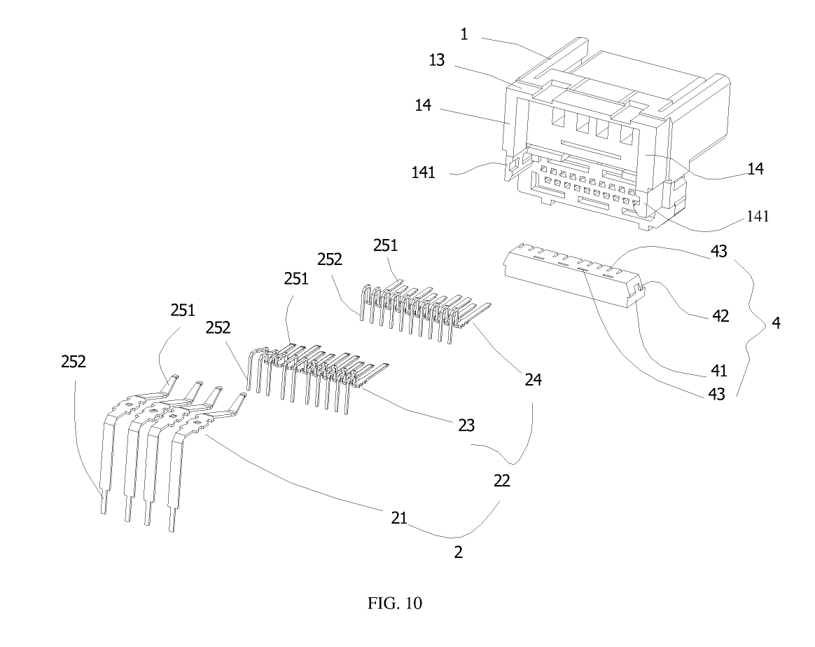

Referring to FIG. 10, a plurality of the conductive terminals 2 are divided into a first terminal group 21 complying with the interface standard of the USB connector socket and a second terminal group 22 complying with the interface standard of the Displayport connector socket according to applications. Each conductive terminal 2 has a contact portion 251 and a tail portion 252 connected with the contact portion 251. Referring to FIG. 6, FIG. 8, and FIG. 10, the contact portions 251 of the first terminal group 21 are provided at a lower side of the first tongue plate 11, and these conductive terminals 2 extend backwards through the housing 1 so that the tail portions 252 of these conductive terminals 2 extend out downwards from the rear portion 13 of the housing 1. The second terminal group 22 is divided into an upper conductive terminal row 23 and an lower conductive terminal row 24, and the contact portions 251 of the upper conductive terminal row 23 and the contact portions 251 of the lower conductive terminal row 24 are respectively mounted on an upper side and a lower side of the second tongue plate 12, and herein the tail portions 252 of the upper conductive terminal row 23 and the tail portions 252 of the lower conductive terminal row 24 extend out downwards from the rear portion 13 of the housing 1. A part of conductive terminals 2 of the upper conductive terminal row 23 is firstly bent and extended leftwards or rightwards by a certain distance along a transverse direction of the housing 1 and then is bent and extended downwards so as to form the tail portion 252, and thus transverse intervals between the tail portions 252 of the upper conductive terminal row 23 are not uniform. As depicted, the “fore-and-aft direction” refers to a direction in which another contact connector plug is mated with the illustrated stacked-type connector, and the “transverse direction” refers to a left-right direction perpendicular to the fore-and-aft direction of the housing 1.

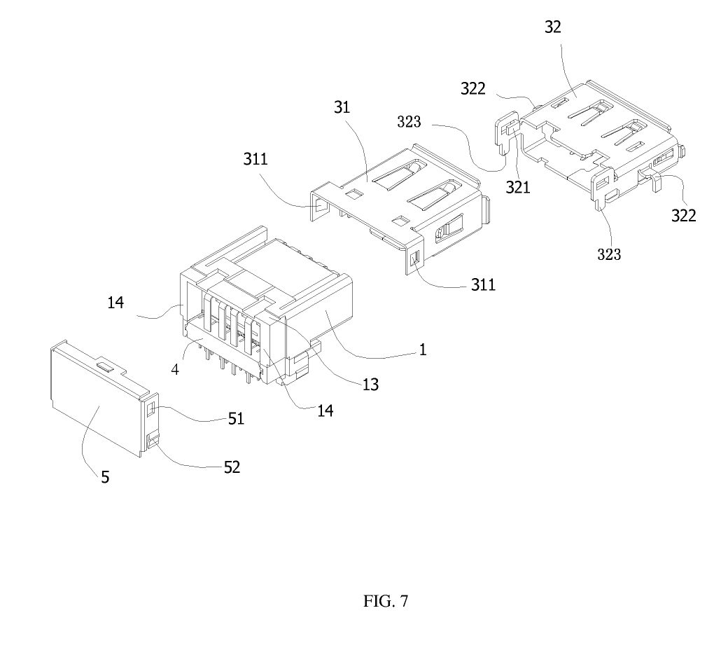

Referring to FIG. 6 and FIG. 7, the first shield 31 and the second shield 32 are formed by bending respective metal sheets. Herein, each of two sides of a rear end of the first shield 31 is formed with a salient piece 311 bent inwards; each of two sides of a rear end of the second shield 32 is formed with a first latching piece 321 by punching and bending inwards and an inserting pin 323 protruding downwards. Also, each of two sides at a central portion of the second shield 32 is formed a fixing pin 322 protruded outwards first and subsequently bent downwards. Referring to FIG. 1 through FIG. 4, both the first shield 31 and the second shield 32 are mounted on the housing 1, herein the USB connector socket is formed by a part of the housing 1 enclosed by the first shield 31, the first tongue plate 11 and the first terminal group 21, and the Displayport connector socket is formed by a part of the housing 1 enclosed by the second shield 32, the second tongue plate 12 and the second terminal group 22.

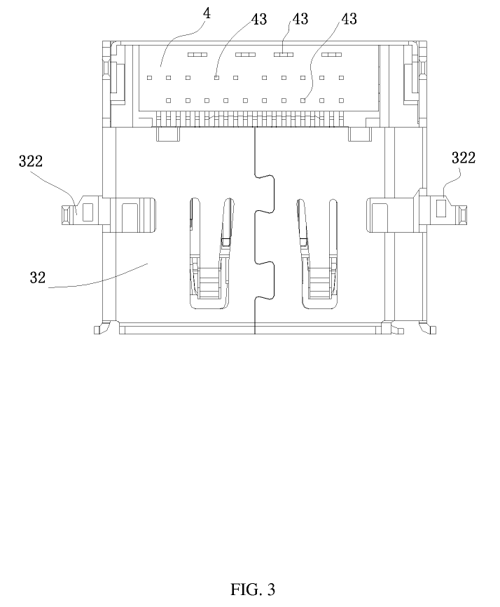

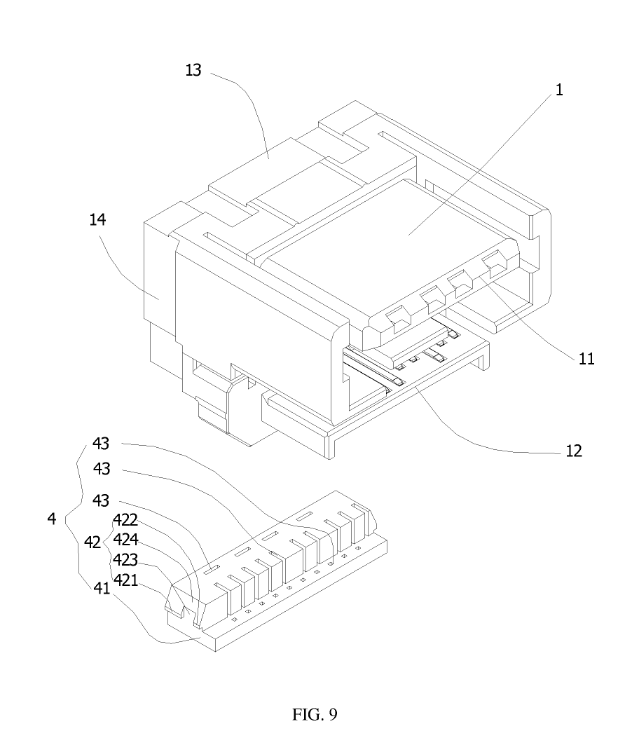

Referring to FIG. 8, FIG. 9 and FIG. 10, the spacer 4 can be formed by injection molding process, and comprises a main body portion 41 and two latching portions 42 protruding outwards respectively from two sides of the main body portion 41. Specifically, each latching portion 42 comprises two protruding portions 422 and 421 arranged along the fore-and-aft direction and a flat portion 423 between the two protruding portions 421 and 422, and is provided with a ramp 424 gradually inclining outwards in top-down direction at an outer side of a top thereof. Three rows of positioning holes 43 extending through the main body portion 41 in top-down direction are provided on the main body portion 41 of the spacer 4, and the tail portions 252 of these conductive terminals 2 are correspondingly inserted into the three rows of the positioning holes 43 and protrude out downwards from a bottom of the main body portion 41. Referring to FIG. 3, transverse intervals between the positioning holes 43 of the spacer 4 for receiving respective tail portions 252 of the conductive terminals 2 in the lower conductive terminal row 24 of the Displayport connector socket are uniform, but transverse intervals between a part of positioning holes 43 for receiving those of the upper conductive terminal row 23 of the second terminal group 22 are not uniform so as to correspond to transverse intervals between a part of the tail portions 252 of the upper conductive terminal row 23.

Referring to FIG. 7 and FIG. 8, the spacer 4 may be mounted into the rear portion of the housing 1 in bottom-up manner, and after the tail portions 252 of the plurality of conductive terminals 2 correspondingly are inserted through the plurality of positioning holes 43 of the spacer 4, the spacer 4 is secured onto the housing 1 by latching and matching the two latching portions 42 with the two buckling portion 141 of the latching arms 14 on the housing 1. At this time, the protruding portions 421, 422 on the two latching portions 42 are correspondingly matched with the recess portions 1411, 1412 on the two latching arms 14, the flat portions 423 on the latching portions 42 correspond to the flat portions 1413 on the latching arms 14, and the ramps 424 of the latching portions 42 correspond to the ramps 1414 of the latching arms 14, so that when the spacer 4 is mounted onto the housing 1 in bottom-up manner, it may be convenient to distract two latching arms 14, and the protruding portions 421, 422 of the spacer 4 correspondingly latch into the recess portions 1411, 1412 of the two latching arms 14, preventing the spacer 4 from falling out downwards. The flat portions 1413 of the latching arms 14 may prevent the protruding portions 422 of the spacer 4 from moving backwards and prevent the spacer 4 from sliding out backwards from the housing 1, so that better fixing effect may be obtained.

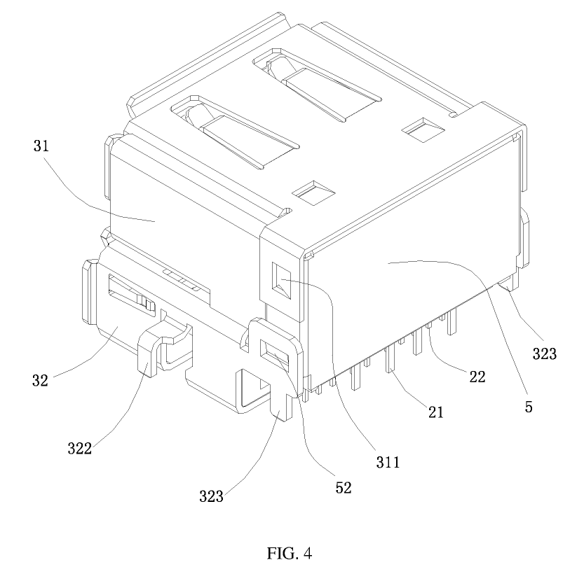

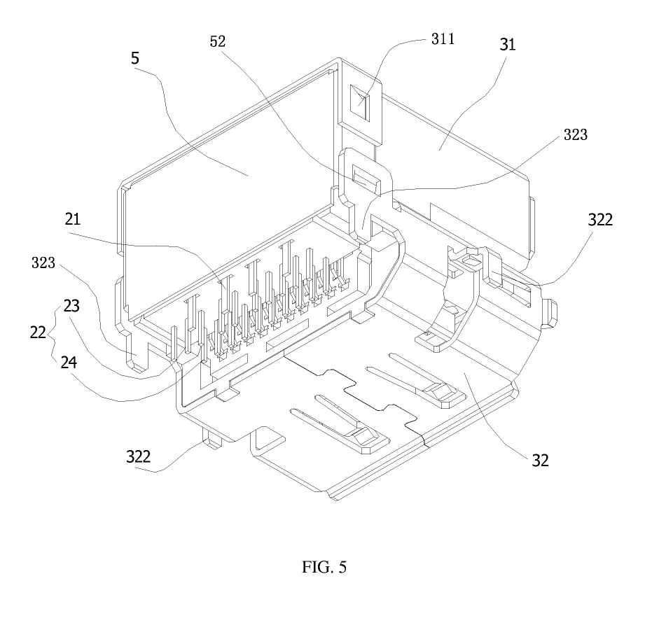

Referring to FIG. 6 and FIG. 7, the rear cover 5 is formed by bending a metal sheet, each of two side walls of the rear cover 5 is provided with a latching hole 51 arranged along a vertical direction and a second latching piece 52 bent downwards and protruding out from a tail end of the each side. Referring to FIG. 4 and FIG. 5, the rear cover 5 is mounted on the rear end of the housing 1 for enclosing the rear portion 13 of the housing 13, the tail portions 252 of the plurality of the conductive terminals 2 and the spacer 4. The latching holes 51 on the two side walls of the rear cover 5 are latched and matched with the salient pieces 311 on two sides of the rear end of the first shield 31, so that the first shield 31 is connected with the rear cover 5. The second latching pieces 52 on the two sides of the rear cover 5 are latched and matched with the first latching pieces 321 on the two sides of the rear end of the second shield 32, so that the second shield 32 is connected with the rear cover 5. The rear cover 5 electrically connects the two shields 31, 32 together and then is grounded via the first shield 31 and the circuit board 8. With the two shields 31, 32 arranged as so, the two connector sockets may more closely match with corresponding connector plugs, so that better fixing effect and electromagnet shield effect may be obtained.

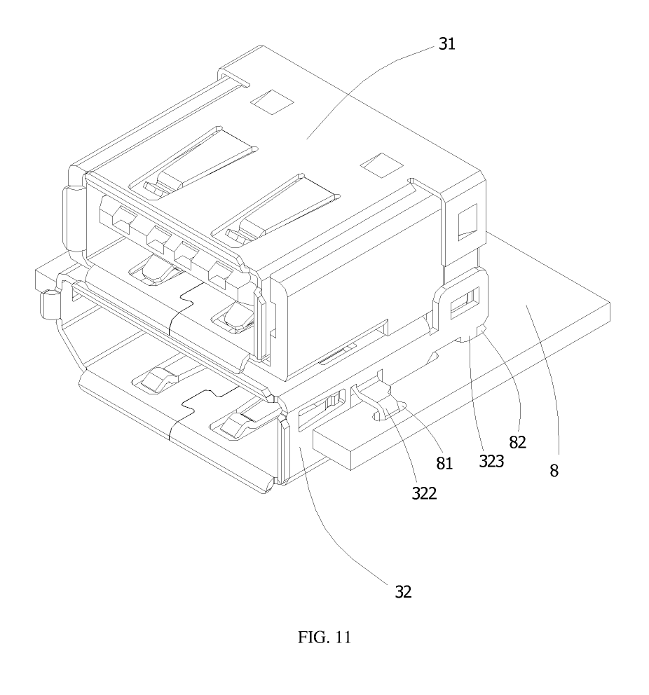

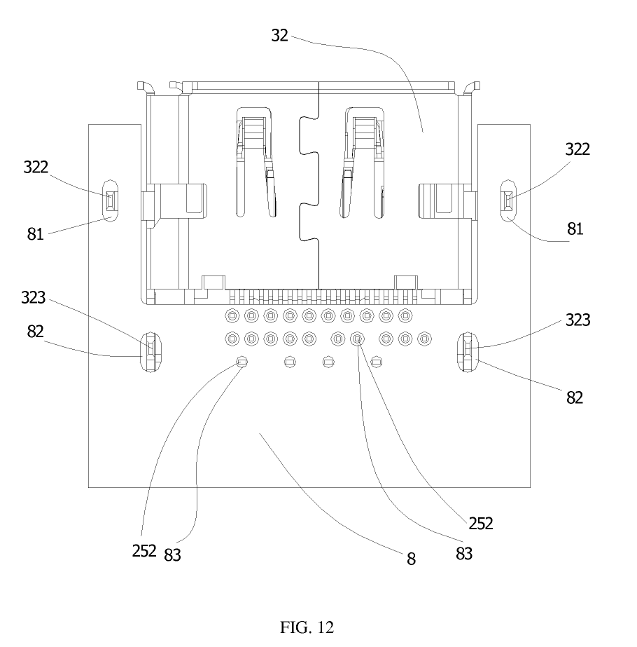

Referring to FIG. 11 and FIG. 12, which illustrate examples of practical application using an embodiment of the stacked-type connector of the disclosure, the stacked-type connector may be soldered onto a circuit board 8. Herein, the tail portions 252 of the plurality of the conductive terminals 2 are correspondingly soldered onto respective soldering holes 83 of the circuit board 8. Two fixing pins 322 of the second shield 32 are correspondingly soldered onto fixing holes 81 of the circuit board 8, and two inserting pins 323 of the second shield 32 are correspondingly soldered onto respective positioning holes 82 of the circuit board 8, so that fixing function may work.

In the stacked-type connector of the disclosure the tail portion 252 of each conductive terminal 2 is correspondingly inserted into the respective positioning hole 43 of the spacer 4. This positioning manner may assure that the intervals along the front, rear, left, and right directions between the conductive terminals 2 are not changed, so as to prevent the tail portions 252 of the conductive terminals 2 from bending due to impact during transportation, which may make the tail portions 252 not correspondingly to be assembled and soldered onto the circuit board 8. Also, since the spacer 4 is assembled onto the housing 1 by latching the two latching portions 42 of the spacer 4 with the two latching arms 14 of the housing 1, and accordingly it is convenient and rapid to mount the space 4 and may have advantage of securable fixation. Herein, the terminals of the lower conductive terminal row 24 of the Displayport connector socket are bent and extended on a longitudinal plane parallel to the fore-and-aft direction, and the rear portions of a part of conductive terminals 2 in the upper conductive terminal row 23 are firstly bent and extended transversely leftwards or rightwards by a certain distance and subsequently bent and extended downwards so as to obtain the tail portion 252, so that transverse intervals between the tail portions 252 of the upper conductive terminal row 23 are not uniform. The arrangement of such non-uniform transverse intervals may enlarge intervals on the circuit board 8 between the tail portions 252 of the signal terminals of the upper conductive terminal row 23 and the tail portions 252 of the signal terminal of the lower conductive terminal row 24 in the Displayport connector socket, so it is advantageous to wire on the circuit board and reduce interference of the signal terminals during high-speed signal transmission. Correspondingly, transverse intervals between the positioning holes 43 of the spacer 4 for receiving the tail portions 252 of the lower conductive terminal row 24 of the Displayport connector socket are uniform, but transverse intervals between the positioning holes 43 of the spacer 4 for receiving the tail portions 252 of the upper conductive terminal row 23 are not uniform.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

What is claimed is:

1. A stacked-type connector, comprising:
a housing with a rear portion and a first tongue plate and a second tongue plate, the first and second tongue protruding forward and respectively arranged in an upper and lower position, the first tongue plate complying with an interface standard of a first connector and the second tongue plate complying with an interface standard of a second connector, the housing further including a first and second latching arm extending from the rear portion;
a plurality of conductive terminals, each terminal having a contact portion and a tail portion, the plurality of conductive terminals comprising a first terminal group complying with the interface standard of the first connector and a second terminal group complying with the interface standard of the second connector, the contact portions of the first terminal group and the contact portions of the second terminal group being respectively provided on the first tongue plate and the second tongue plate of the housing, and the tail portions of the first terminal group and the tail portions of the second terminal group extending out from the rear portion of the housing;
at least one shield mounted on the housing; and
a spacer comprising a main body portion with a top and bottom and two sides, the spacer including a first and second latching portion protruding outwards respectively from the two sides, wherein the first and second latching arm are respectively matched with the first and second latching portion so as to secure the spacer on the rear portion of the housing, wherein a plurality of positioning holes extend through the spacer in an vertical direction, and the tail portions of the plurality of the conductive terminals extend from the top of the spacer through the positioning holes and further protruded below the bottom of the spacer.

2. The stacked-type connector according to claim 1, wherein each latching arm of the housing is provided with a buckling portion at an inner side thereof, and the buckling portion comprises at least one recess portion; each of the latching portions of the spacer comprises at least one protruding portion; the at least one protruding portion of the latching portion is correspondingly matched with the at least one recess portion of the latching arm.

3. The stacked-type connector according to claim 2, wherein each buckling portion of the housing comprises two recess portions arranged along a fore-and-aft direction and a flat portion between the two recess portions; each latching portion of the spacer comprises two protruding portions arranged along the fore-and-aft direction and a flat portion between the two protruding portions; the two protruding portions of the latching portion and the two recess portions of the latching arm are matched with each other, and the flat portion of the latching portion and the flat portion of the each latching arm are corresponded to each other.

4. The stacked-type connector according to claim 3, wherein each buckling portion of the housing is provided with a ramp gradually inclining inwards in bottom-up direction at an inner side of a tail end thereof, and each latching portion of the spacer is correspondingly provided with a ramp gradually inclining outwards in top-down direction at a top thereof.

5. The stacked-type connector according to claim 1, wherein the second terminal group comprises an upper conductive terminal row and a lower conductive terminal row respectively mounted on an upper surface and a lower surface of the second tongue plate;
and wherein transverse intervals between the positioning holes in the spacer for receiving the tail portions of the lower conductive terminal row are uniform, and the transverse intervals between the positioning holes in the spacer for receiving the tail portions of the upper conductive terminal row are not uniform.

6. The stacked-type connector according to claim 5, wherein rear portions of a part of the conductive terminals of the upper conductive terminal row are firstly bent and extended by a certain distance along a transverse direction and then bent and extended downwards to obtain the tail portion, so that the transverse intervals between the tail portions of the upper conductive terminal row are not uniform.

7. The stacked-type connector according to claim 1, wherein the first connector is an USB connector socket, and the second connector is a Displayport connector socket.

8. The stacked-type connector according to claim 1, wherein the at least one shield comprises a first shield and a second shield respectively enclosing outer peripherals of the first terminal group and the second terminal group.

9. The stacked-type connector according to claim 8, further comprising a rear cover mounted on a rear side of the housing and connected with the first shield and the second shield.

10. The stacked-type connector according to claim 9, wherein each of two side walls of the rear cover is provided with a latching hole and a second latching piece; each of two sides of a rear end of the first shield is formed with a salient piece bent inwards, the salient pieces are latched and matched with the latching holes on the rear cover so that the first shield is connected with the rear cover; each of two sides of a rear end of the second shield is formed with a first latching piece, and the first latching pieces are latched and matched with the second latching pieces of the rear cover so that the second shield is connected with the rear cover.
